(19) United States
(12) Patent Application Publication
(10) Pub. No.: US 2026/0036525 A1
(43) Pub. Date: Feb. 5, 2026

(54) INSPECTION APPARATUS AND METHODS OF USING THE SAME

(71) Applicant: Taiwan Semiconductor Manufacturing Company, Ltd., Hsinchu (TW)

(72) Inventors: Chia-Chin Li, Taichung City (TW); Wei Wu, Hsinchu (TW)

(73) Assignee: Taiwan Semiconductor Manufacturing Company, Ltd., Hsinchu (TW)

(21) Appl. No.: 18/795,067

(22) Filed: Aug. 5, 2024

(51) Int. Cl. G01N 21/95; G01B 11/16; G01N 1/44; G01N 21/88

(52) U.S. Cl. CPC G01N 21/9501; G01B 11/167; G01N 1/44; G01N 21/8806; G01N 2201/0231

(57) ABSTRACT

An inspection apparatus for a warpage of a semiconductor die includes a carrier, a thermal isolation material, a holding unit, a heater, a transparent cover, a light source, and a capture device. The thermal isolation material is disposed over the carrier. The holding unit stands on and is in contact with the thermal isolation material. The heater is disposed inside the holding unit and is configured to heat the semiconductor die. The transparent cover stands on and is in contact with the holding unit, where the semiconductor die is disposed between the transparent cover and the heater. The light source is disposed over the transparent cover and is configured to project a light having a pattern to the semiconductor die. The capture device is disposed over the transparent cover and is configurated to capture an image of the semiconductor die for inspecting the warpage of the semiconductor die after heating.

### BACKGROUND

Developments in shrinking sizes of semiconductor devices and electronic components make the integration of more devices and components into a given volume possible and lead to high integration density of various semiconductor devices and/or electronic components.

### BRIEF DESCRIPTION OF THE DRAWINGS

Aspects of the disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1, FIG. 2 and FIG. 3 are schematic cross-sectional and plane views of an inspection apparatus in accordance with some embodiments of the disclosure.

FIG. 4 and FIG. 5 are schematic cross-sectional views of an inspection apparatus in accordance with alternative embodiments of the disclosure.

FIG. 6 and FIG. 7 are schematic cross-sectional views of an inspection apparatus in accordance with alternative embodiments of the disclosure.

FIG. 8 and FIG. 9 are schematic cross-sectional views of an inspection apparatus in accordance with alternative embodiments of the disclosure.

FIG. 10 and FIG. 11 illustrates flowcharts of a method for using an inspection apparatus in accordance with some embodiments of the disclosure.

FIG. 12 through FIG. 17 are schematic cross-sectional or plane views of various stages of a method using an inspection apparatus for warpage of a semiconductor die in accordance with some embodiments of the disclosure.

### DETAILED DESCRIPTION

The following disclosure provides many different embodiments, or examples, for implementing different features of the provided subject matter. Specific examples of components, values, operations, materials, arrangements, or the like, are described below to simplify the disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In addition, terms, such as “first”, “second”, “third”, “fourth”, “fifth”, “sixth”, “seventh”, and the like, may be used herein for ease of description to describe similar or different element(s) or feature(s) as illustrated in the figures, and may be used interchangeably depending on the order of the presence or the contexts of the description.

As used herein, “around,” “about,” “approximately,” or “substantially” shall generally mean within 20 percent, or within 10 percent, or within 5 percent, or within 3 percent, or within 1 percent of a given value or range. Numerical quantities given herein are approximate, meaning that the term “around,” “about,” “approximately,” or “substantially” can be inferred if not expressly stated.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

In some embodiments, the method is part of a wafer level packaging process. It is understood that additional processes may be provided before, during, and after the illustrated method, and that some other processes may only be briefly described herein. In the disclosure, it should be appreciated that the illustration of components throughout all figures is schematic and is not in scale.

It should be appreciated that the following embodiment(s) of the disclosure provides applicable concepts that can be embodied in a wide variety of specific contexts. The embodiments are intended to provide further explanations but are not used to limit the scope of the disclosure. The specific embodiment(s) described herein is related to an inspection apparatus and its using method during a manufacture of a semiconductor die (or chip) to-be-further packaged with another a semiconductor device (such as another semiconductor die (or chip), a semiconductor wafer, a circuit board, an interposer, or the like), and is not intended to limit the scope of the disclosure. In some embodiments, the semiconductor die (or chip), which passes the inspection, may be further packaged (or integrated) into a form of a system-on-integrated-circuit (SoIC) device, an integrated fan-out (InFO) package, a chip-on wafer (CoW) package, or a chip-on wafer-on-substrate (CoWoS) package, a package-on-package (PoP), an InFO package with POP, a wafer-level package (WLP), or the like. The disclosure is not limited thereto. In accordance with some embodiments, the inspection apparatus includes a thermal isolation material (or insulating material) between a heater and a carrier so to ensure a semiconductor die (or chip) to-be-inspected (which can be the semiconductor die (or chip) may be further packaged in a sequential process if passing the inspection) be the main object to be heated by the heater, not the ambient air; and thus the air disturbance impact to an optical data acquisition during the inspection can be suppressed or reduced. In accordance with some embodiments, the inspection apparatus includes a transparent cover disposed over the semiconductor die (or chip) to-be-inspected with a distance vertically therebetween, and the distance is greater than zero and less than or substantially equal to 3 mm. Owing to such distance, less ambient air above the semiconductor die (or chip) to-be-inspected is heated during the inspection, and thus the air disturbance impact to an optical data acquisition during the inspection can be also suppressed or reduced. In the disclosure, the inspection apparatus has high precision in warp inspection of the semiconductor die (or chip) with less than 1.5 μm variation.

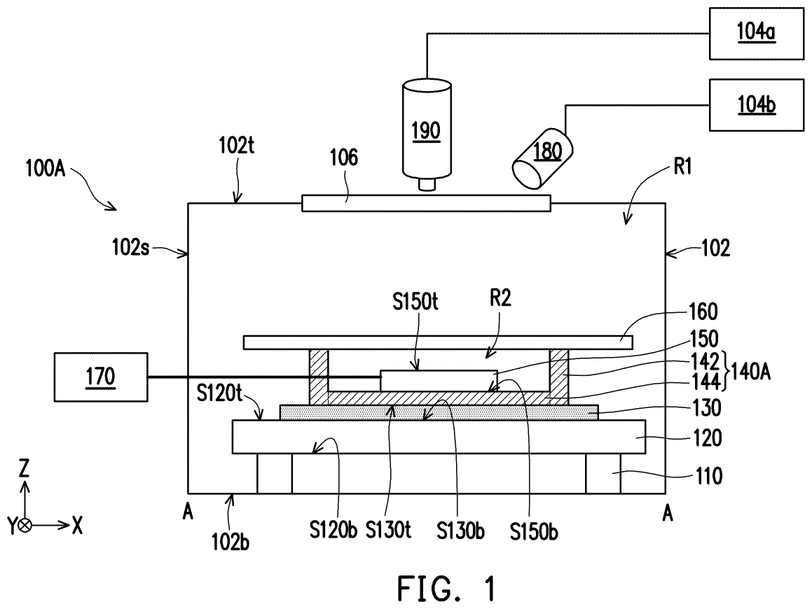

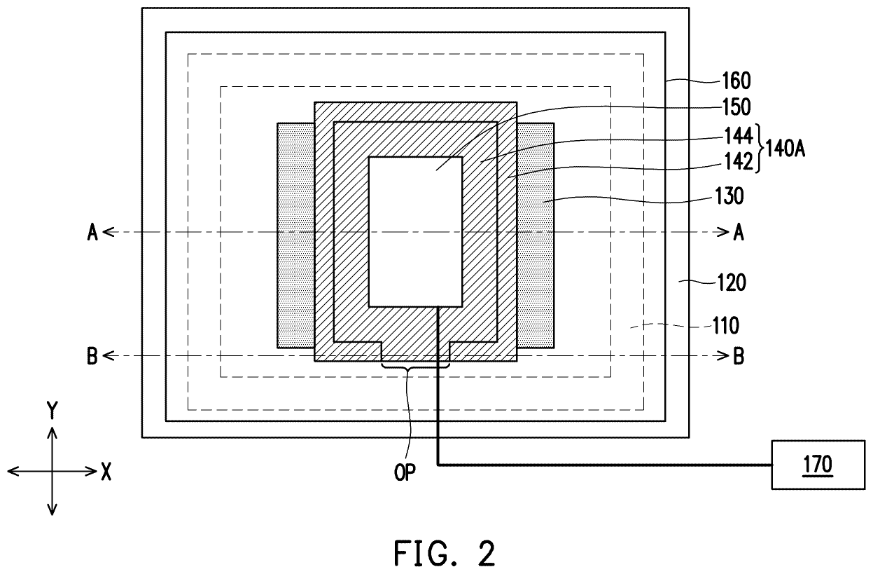

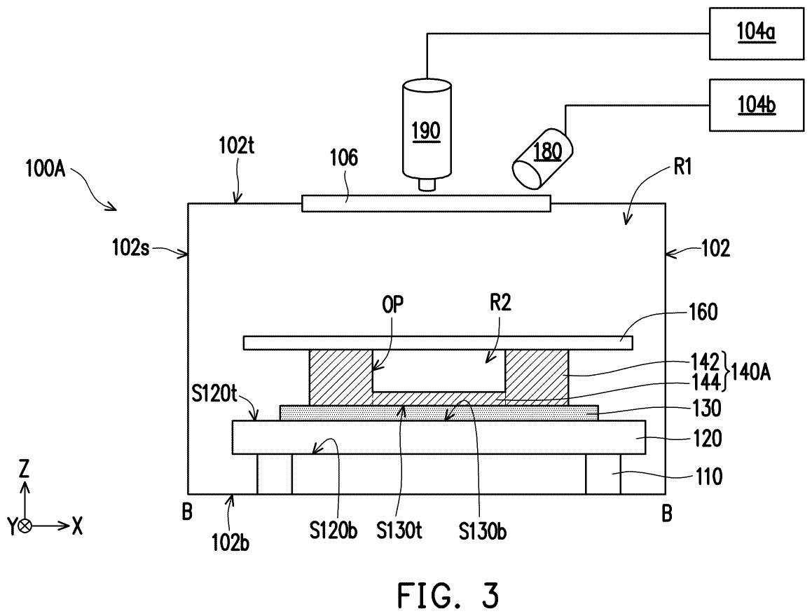

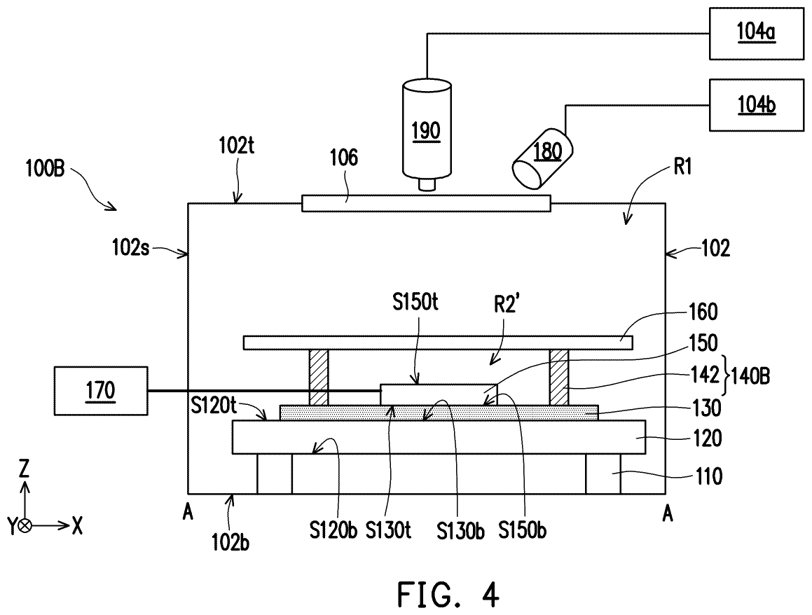

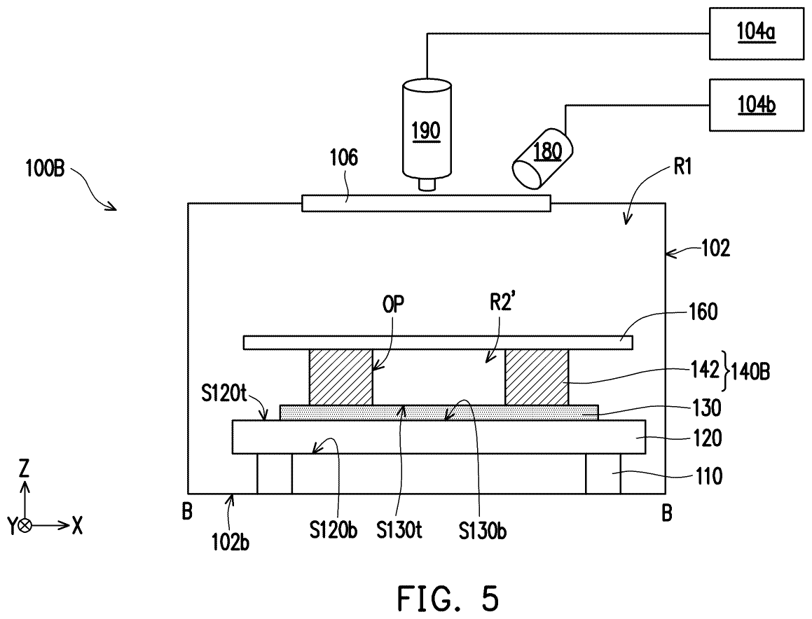

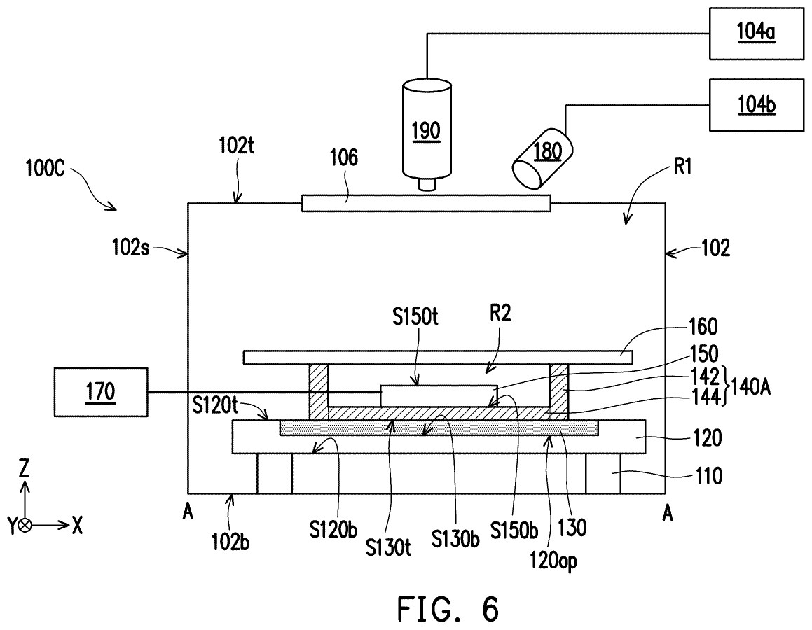

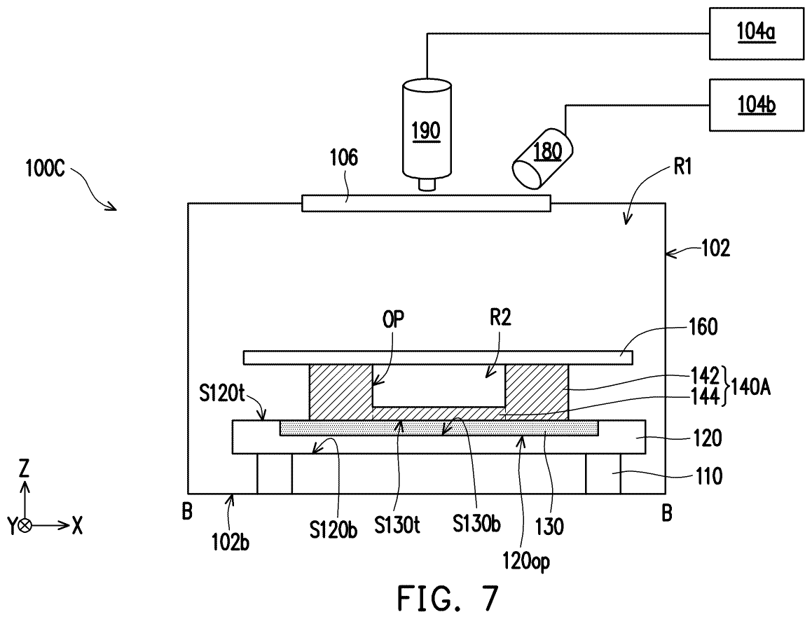

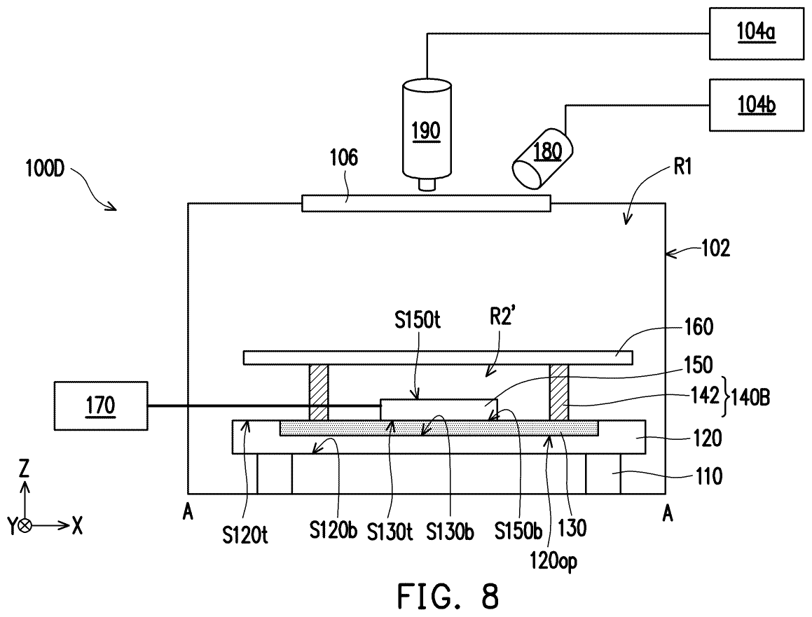

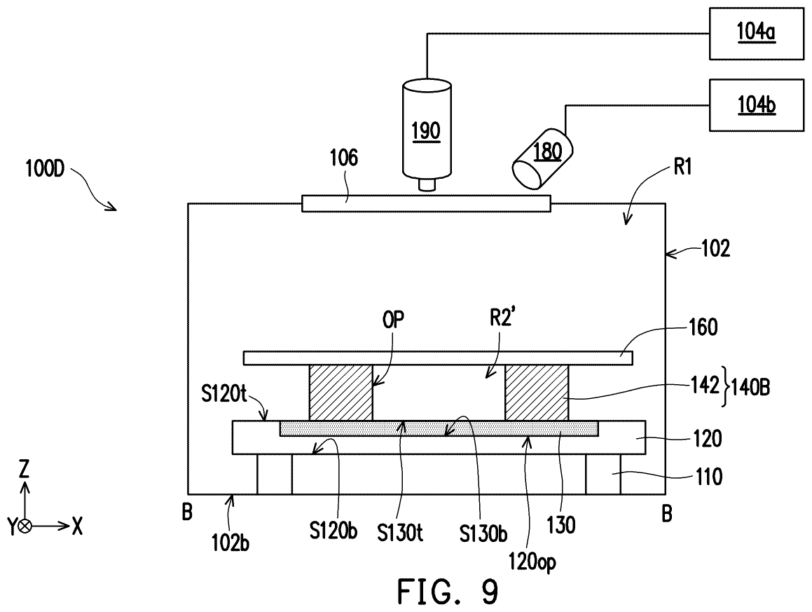

FIG. 1, FIG. 2 and FIG. 3 are schematic cross-sectional and plane views of an inspection apparatus (e.g., 100A) in accordance with some embodiments of the disclosure, where the schematic cross-sectional view of FIG. 1 is taken along a line A-A depicted in the schematic plane view of FIG. 2, and the schematic cross-sectional view of FIG. 3 is taken along a line B-B depicted in the schematic plane view of FIG. 2. FIG. 4 and FIG. 5 are schematic cross-sectional views of an inspection apparatus (e.g., 100B) in accordance with alternative embodiments of the disclosure, where the schematic cross-sectional view of FIG. 4 is taken along the line A-A depicted in the schematic plane view of FIG. 2, and the schematic cross-sectional view of FIG. 5 is taken along the line B-B depicted in the schematic plane view of FIG. 2. FIG. 6 and FIG. 7 are schematic cross-sectional views of an inspection apparatus (e.g., 100C) in accordance with alternative embodiments of the disclosure, where the schematic cross-sectional view of FIG. 6 is taken along the line A-A depicted in the schematic plane view of FIG. 2, and the schematic cross-sectional view of FIG. 7 is taken along the line B-B depicted in the schematic plane view of FIG. 2. FIG. 8 and FIG. 9 are schematic cross-sectional views of an inspection apparatus (e.g., 100D) in accordance with alternative embodiments of the disclosure, where the schematic cross-sectional view of FIG. 8 is taken along the line A-A depicted in the schematic plane view of FIG. 2, and the schematic cross-sectional view of FIG. 9 is taken along the line B-B depicted in the schematic plane view of FIG. 2. For clarity of illustrations, the drawings are illustrated with orthogonal axes (X, Y and Z) of a Cartesian coordinate system according to which the views are oriented; however, the disclosure is not specifically limited thereto. Throughout the various views and illustrative embodiments of the disclosure, the elements similar to or substantially the same as the elements described previously will use the same reference numbers, and certain details or descriptions (e.g., the materials, formation processes, positioning configurations, electrical connections, etc.) of the same elements would not be repeated.

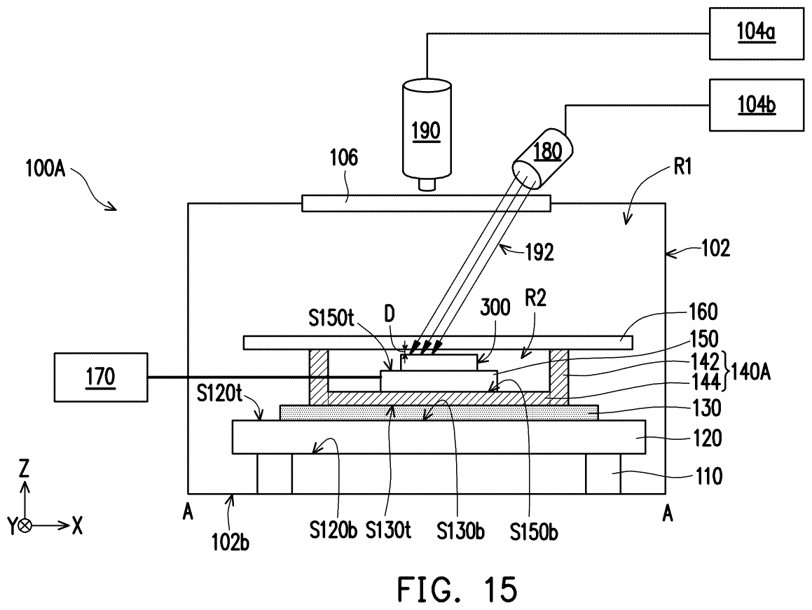

Referring to FIG. 1, FIG. 2 and FIG. 3, in some embodiments, an inspection apparatus 100A is provided. In some embodiments, the inspection apparatus 100A is configured to inspect the warpage of a semiconductor die (or chip) and determine whether the semiconductor die (or chip) being inspected pass the criteria for a sequential process. For example, the sequential process may include joint process, and the criteria is thus considered as joint criteria. As shown in FIG. 1 and FIG. 2, the inspection apparatus 100A includes a stand 110, a carrier 120 placed over the stand 110, an insulating material 130 over the carrier 120, a holding unit 140A disposed on the insulating material 130, a heater 150 placed inside the holding unit 140A, and a cover 160 covering the holding unit 140A and the heater 150, where in an inspection (e.g., thermal warp inspection), an object to-be-inspected (e.g., 300 in FIG. 15) is vertically placed between the heater 150 and the cover 160, for example. In some embodiments, the inspection apparatus 100A further includes a power supply 170 electrically coupled to the heater 150, a light source 180 over the cover 160, and a capture device 190 over the cover 160. In some embodiments, the inspection apparatus 100A further includes a chamber 102 accommodating the standing 110, the carrier 120, the insulating material 130, the holding unit 140A, the heater 150, and the cover 160, where the light source 180 and the capture device 190 are disposed over the chamber 102.

In some embodiments, the chamber 102 may be includes a top portion 102t, a bottom portion 102b opposite to the top portion 102t, and a sidewall portion 102s connecting the top portion 102t and the bottom portion 102b. As shown in FIG. 1, the chamber 102 includes a cover 106 disposed in the top portion 102t, where the cover 106 is a transparent cover that allows the capture device 190 to take images therethrough and the light source 180 to emit light therethrough. The cover 106 may be a high transparent glass cover. For example, a material of the cover 106 includes a material of low refractive index. In some embodiments, the top portion 102t (including the cover 106), the bottom portion 102b and the sidewall portion 102s form a space R1 for accommodating the standing 110, the carrier 120, the insulating material 130, the holding unit 140A, the heater 150, and the cover 160, where the light source 180 and the capture device 190 are disposed directly over the cover 106 of the chamber 102. In some embodiments, the space R1 may be sized to fit a single wafer substrate. However, in certain embodiments, the space R1 may be large enough to fit multiple wafer substrates.

In some embodiments, the chamber 102 is made of a material with a sufficient stiffness (which may be quantified by its Yong's modulus) for protecting elements disposed therein. The material of the chamber 102 may include a conductive material, a dielectric material, or a combination of dielectric material and conductive material. For example, a material of the chamber 102 includes a metal or metal alloy, such as stainless steel, iron (Fe), chromium (Cr), nickel (Ni), Aluminum (Al), combinations thereof, or the like. The disclosure is not limited thereto.

Although it is not shown, it should be appreciated that the inspection apparatus 100A may further include a housing for accommodating the chamber 102, the light source 180 and the capture device 190, where the power supply 170 is disposed outside the housing and the chamber 102. In some embodiments, the housing includes one or more inlets and outlets (not depicted) to allow the insertion and removal of the object to-be-inspected from the space R1.

In some embodiments, the stand 110 is disposed at the bottom portion 102b of the chamber 102 and extending upward to a position inside the space R1 for supporting the carrier 120. For example, the stand 110 may be made of a dielectric material having sufficient stiffness (which may be quantified by its Yong's modulus) to hold/maintain the carrier 120 in a proper position to the chamber 102 during a thermal process. The stand 110 may be quartz or the like, the disclosure is not limited thereto. As shown in the plane view (e.g., a X-Y plane) of FIG. 2, the stand 110 may be in form of a frame shape. For example, in the plane view, the stand 110 have an annular shape extending along edges of the carrier 120. In some embodiments, the stand 110 can be referred to as a supporting structure or a holding component.

In some embodiments, the carrier 120 is disposed on (e.g., in contact with) the stand 110 and inside the chamber 102. As shown in FIG. 1, the carrier 120 may directly laid on (e.g., stand on or be in physical contact with) the stand 110, where the carrier 120 may be securely held by the stand 110. For example, the carrier 120 includes a carbon carrier. In some embodiments, on the plane view (e.g., the X-Y plane) in a stacking direction (e.g., a direction Z), a projection of the carrier 120 covers a projection of the stand 110 and extends beyond the stand 110, see FIG. 1 and FIG. 2. For example, the carrier 120 has a surface S120t and a surface S120b opposing to the surface S120t, where the surface S120b of the carrier 120 is in direct contact with the stand 110. As shown in FIG. 1 and FIG. 2, the carrier 120 may be in a plate form. In some embodiments, if considering a top or plane view (e.g., the X-Y plane) along the direction Z, the carrier 120 has a square shape. However, the disclosure is not limited thereto; alternatively, in the top or plane view along the direction Z, the carrier 120 may have a rectangular shape, a circular shape, an oval shape, an elliptical shape, a polygonal shape or any other suitable shape.

In some embodiments, the insulating material 130 is disposed over the carrier 120 and inside the chamber 102. As shown in FIG. 1, the insulating material 130 may directly laid on (e.g., stand on or be in physical contact with) the surface S120t of the carrier 120, where the surface S120t is a substantially planar surface. For example, a material of the insulating material 130 includes a heat-resist resin or a heat-isolated ceramic. In some embodiments, on the plane view (e.g., the X-Y plane) in the stacking direction (e.g., the direction Z), a projection of the insulating material 130 covers the projection of the carrier 120. For example, the projection of the insulating material 130 is within the projection of the carrier 120, see FIG. 1 and FIG. 2. For example, the insulating material 130 has a surface S130t and a surface S130b opposing to the surface S130t, where the surface S130b of the insulating material 130 is in direct contact with the carrier 120 (e.g., the surface S120t).

As shown in FIG. 1 and FIG. 2, the insulating material 130 may be in a plate form. In some embodiments, if considering the top or plane view (e.g., the X-Y plane) along the direction Z, the insulating material 130 has a square shape. However, the disclosure is not limited thereto; alternatively, in the top or plane view along the direction Z, the insulating material 130 may have a rectangular shape, a circular shape, an oval shape, an elliptical shape, a polygonal shape or any other suitable shape. In a non-limiting example, a sidewall of the insulating material 130 is surrounded by an inner sidewall of the stand 110, in the plane view of FIG. 2. However, the disclosure is not limited thereto; alternatively, a sidewall of the insulating material 130 may be between an outer sidewall and an inner sidewall of the stand 110, in the plane view. In another non-limiting example, a sidewall of the insulating material 130 may be aligned with an outer sidewall of the stand 110, in the plane view. Or alternatively, an outer sidewall of the stand 110 may be surrounded by a sidewall of the insulating material 130, in the plane view. In some embodiments, the insulating material 130 can be referred to as an isolation material, an insular, a thermal isolation material, or a thermal insular. For example, the insulating material 130 is a thermal isolation brick. In some embodiments, a thickness (not labeled, as measured in the direction Z) of the insulating material 130 may be approximately ranging from 1.5 cm to 7.0 cm. For example, the thickness (as measured in the direction Z) of the insulating material 130 is about 3.5 cm to about 5.0 cm.

In some embodiments, the holding unit 140A is disposed over the insulating material 130 and inside the chamber 102. As shown in FIG. 1, the holding unit 140A may directly laid on (e.g., stand on or be in physical contact with) the surface S130t of the insulating material 130, where the surface S130t is a substantially planar surface. For example, as shown in FIG. 1, the holding unit 140A includes a first portion 142 and a second portion 144 connecting to the first portion 142, where the first portion 142 extends in the stacking direction Z while the second portion 144 extends in the X-Y plane. In some embodiments, the first portion 142 is connected to the second portion 144 by direct contact, where the second portion 144 connects to a sidewall of the first portion 142. For example, the first portion 142 and the second portion 144 are an integral piece. In some embodiments, the first portion 142 extends along and connected to the edge of the second portion 144. The holding unit 140A may be made of a metal or a metal alloy. For example, the holding unit 140A is made of Al. In some embodiments, the holding unit 140A can be referred to as a holding device, a holder, a conductive holder, a metallization holder, a metallic holder, a metal holder, a case, a conductive case, a metallization case, a metallic case, or a metal case. In some embodiments, the first portion 142 may be referred to as a vertical portion, a ring portion or a flange portion, and the second portion 144 may be referred to as a horizontal portion or a plate portion. However, the disclosure is not limited thereto, alternatively, the second portion 144 may be omitted (see FIG. 3 and FIG. 5). As shown in FIG. 2 and FIG. 3, the first portion 142 has an opening OP for allowing external connection to an internal element (e.g., the heater 150), for example. The power supply 170 may be connected to and electrically coupled to the heater 150 through the opening OP formed in the first portion 142 of the holding unit 140A, as shown in FIG. 2. In some embodiments, the insulating material 130 physically separates the carrier 120 from the holding unit 140A in the direction Z. As shown in FIG. 2, the projection of the insulating material 130 extends beyond a projection of the holding unit 140A in the direction X, for example. However, the disclosure is not limited thereto; alternatively, the projection of the insulating material 130 extends beyond the projection of the holding unit 140A in the direction Y. Or alternatively, the projection of the insulating material 130 extends beyond the projection of the holding unit 140A in the direction X and the direction Y. Or, owing to the configuration of the insulating material 130, the projection of the insulating material 130 does not extend beyond the projection of the holding unit 140A in the direction X and the direction Y. In some embodiments, in the direction Z, a thickness of the second portion 144 is less than a thickness of the first portion 142.

In some embodiments, the heater 150 is disposed over the holding unit 140A and inside the chamber 102. As shown in FIG. 1, the heater 150 may directly laid on (e.g., stand on or be in physical contact with) the second portion 144 of the holding unit 140A and surrounded by the first portion 142. The heater 150 has a surface S150t and a surface S150b opposing to the surface S150t, where the surface 150b of the heater is in direct contact with the second portion 144 of the holding unit 140A and the surface S150t is below an illustrated top surface of the first portion 142. That is, the heater 150 is placed inside the holding unit 140A. The heater 150 is electrically coupled to the power supply 170 through the opening OP of the holding unit 140A, for example. In some embodiments, the heater 150 is a ceramic coil heater. In some embodiments, the power supply 170 provides a current to the heater 150, where the current flows through coil(s) of the heater 150 (such as resistance wire), the heat generated from the resistive heating of coil(s) is conducted across the insulation (such as ceramic) covering the coil(s) of the heater 150, so to heat the object to-be-inspected (e.g., 300 in FIG. 15, which will be placed onto the heater 150). In some embodiments, the power supply 170 includes a heating power system with PID controller to control a heating temperature of the heater 150. The power supply 170 may be referred to as a heating power system or a temperature controller of the heater 150. For example, the power supply 170 is disposed outside the housing.

In some embodiments, the cover 160 is disposed over the holding unit 140A and inside the chamber 102. As shown in FIG. 1, the cover 160 may directly laid on (e.g., stand on or be in physical contact with) the first portion 142 of the holding unit 140A and over the heater 150. In some embodiments, the cover 160 and the holding unit 140A form a space R2 for accommodating the heater 150 and the object to-be-inspected (e.g., 300 in FIG. 15). In some embodiments, the space R2 may be sized to fit a single heater 150 with a single die disposed thereon. However, in certain embodiments, the space R2 may be large enough to fit one or multiple sets of a single heater 150 with multiple dies disposed thereon. Or, the space R2 may be large enough to fit multiple sets of a single heater 150 with a single die disposed thereon. The cover 160 may be a high transparent glass cover. For example, a material of the cover 160 includes a material of low refractive index. In some embodiments, the cover 160 is a transparent cover that allows the capture device 190 to take images therethrough and the light source 180 to emit light therethrough. In some embodiments, the material of the cover 160 and the material of the cover 106 are the same. Alternatively, the material of the cover 160 and the material of the cover 106 are different. The disclosure is not limited thereto. In some embodiments, the cover 160 is removably disposed on the holding unit 140A, which allows placing the object to-be-inspected on the heater 150 in the space R2 or removing the object to-be-inspected from the heater 150.

In some embodiments, the light source 180 and the capture device 190 are disposed over the cover 160 and outside the chamber 102. For example, the light source 180 and the capture device 190 are each vertically disposed on the chamber 102 by a gap and inside the housing. In other words, the light source 180 and the capture device 190 are physically engaged with the housing and distant from the chamber 102. The light source 180 may project (or irradiate) a light onto the object to-be-inspected (e.g., 300) which would be placed inside the chamber 102 and over the heater 150 (also see FIG. 15), in an inspection (which will be discussed in greater details below). The light may be a visible light. For example, the light source 180 projects a visible light of a pre-determined pattern onto the object to-be-inspected through the cover 106, in the inspection. In such case, the visible light of the pre-determined pattern passes through the cover 106 of the chamber 102 so to be projected to the object to-be-inspected. In other words, the cover 106 and the object to-be-inspected are located at the light path of the light projected (or irradiated) by the light source 180. In some embodiments, the pre-determined pattern of the (visible) light may be a strip pattern or moiré pattern, the disclosure is not limited thereto. In some embodiments, the light source 180 may be referred to as a projector, a light projector, a visible light projector, a light emitting source, or a visible light emitting source. As shown in FIG. 1 and FIG. 3, a processing unit 104b may be electrically coupled to the light source 180 for controlling the light source 180. For example, the processing unit 104b controls the pre-determined pattern (e.g., shape, line width, line spacing, or the like) of the (visible) light to be projected to the object to-be-inspected by the light source 180.

As shown in FIG. 1 and FIG. 3, the capture device 190 may be laterally next to the light source 180. In some embodiments, the capture device 190 is vertically disposed above the cover 106 and over the object to-be-inspect, so the capture device 190 is capable of capturing an image of a projected pattern of the (visible) light from the object to-be-inspected. In some embodiments, the light source 180 projects the (visible) light of pre-determined pattern, and after the (visible) light of pre-determined pattern is projected to the object to-be-inspected and is observed, such observed light pattern from the object to-be-projected can be referred to as the projected pattern of the (visible) light. That is, the projected pattern of the (visible) light is the pattern of the (visible) light (which having the pre-determined pattern) being projected to the object to-be-inspected by the light source 180 and being observed from the object to-be-inspected. The capture device 190 may be referred to as an image capture device, or an optical capture device. In some embodiments, the capture device 190 includes a camera. For example, the capture device 190 is a CCD camera. As shown in FIG. 1 and FIG. 3, a processing unit 104a may be electrically coupled to the capture device 190 for controlling the capture device 190. For example, the processing unit 104a controls the number of images being captured by the capture unit 190 at a point of time, such as one image per time, two images per time, three images per time, or more images per times based on the demand. In addition, the processing unit 104a also processes the images captured by the capture device 190 from an optical data to a digital data, so to transform the digital data into a 3D surface shape construction (which is done by calculating a distance between the capture device 190 and the object to-be-inspected). To be specific, such distance includes a set of distances between the capture device 190 and different portions of the object to-be-inspected, so that a topography of the object to-be-inspected can be reconstructed to form the 3D surface shape for the object to-be-inspected, which is allow to determine the warpage of the object to-be-inspected. In one non-limiting example, if considering a distance between the edge of the object to-be-inspected and the capture device 190 is greater than a distance between the center of the object to-be-inspected and the capture device 190, then the 3D surface shape of the object to-be-inspected would be illustrated or shown as a convex 3D curved surface having a cry-shape in a cross-section thereof. In another non-limiting example, if considering a distance between the edge of the object to-be-inspected and the capture device 190 is less than a distance between the center of the object to-be-inspected and the capture device 190, then the 3D surface shape of the object to-be-inspected would be illustrated or shown as a concave 3D curved surface having a smile-shape in a cross-section thereof. In yet another non-limiting example, if considering a distance between the edge of the object to-be-inspected and the capture device 190 is substantially equal to a distance between the center of the object to-be-inspected and the capture device 190, then the 3D surface shape of the object to-be-inspected would be illustrated or shown as a planar surface having a plate shape in a cross-section thereof.

In some embodiments, as shown in FIG. 1 and FIG. 3, the processing unit 104a is electrically coupled to the capture device 190, and the processing unit 104b is electrically coupled to the light source 180 for controlling the capture device 190 and the light source 180, separately. However, the disclosure is not limited thereto. Alternatively, the capture device 190 and the light source 180 may be electrically coupled to a single processing unit which is capable of controlling the capture device 190 and the light source 180 simultaneously or periodically. In some embodiments, the processing units 104a, 104b independently may be referred to as a processer, a controller, or a control system. For example, the processing units 104a, 104b independently may be or include a device such as a logic chip (e.g., a central processing unit (CPU), a graphics processing unit (GPU), and a microcontroller) or other programmable microprocessor. For example, the processing units 104a, 104b are disposed outside the housing.

In some embodiments, the holding unit 140A may be substituted by a holding unit 140B, see an inspection apparatus 100B. An inspection apparatus 100B of FIG. 4 and FIG. 5 is similar to the inspection apparatus 100A of FIG. 1 through FIG. 3, a difference is that, in the inspection apparatus 100B of FIG. 4 and FIG. 5, the holding unit 140A is substituted by a holding unit 140B, where the holding unit 140B includes the first portion 142 and excludes the second portion 144. The elements similar to or substantially the same as the elements described previously will use the same reference numbers, and certain details or descriptions (e.g., the materials, formation processes, positioning configurations, etc.) of the same elements would not be repeated herein.

As shown in FIG. 4 and FIG. 5, the insulating material 130, the holding unit 140B and the cover 160 together form a space R2′ for accommodating the heater 150 and the object to-be-inspected (e.g., 300 in FIG. 15). In some embodiments, the space R2′ may be sized to fit a single heater 150 with a single die disposed thereon. However, in certain embodiments, the space R2′ may be large enough to fit one or multiple sets of a single heater 150 with multiple dies disposed thereon. Or, the space R2′ may be large enough to fit multiple sets of a single heater 150 with a single die disposed thereon. In some embodiments, the heater 150 is directly placed onto the insulating material 130. As shown in FIG. 4, the surface S150b of the heater 150 is in physical contact with the surface S130t of the insulating material 130.

In such configuration of the insulating material 130 and the holding unit 140B, the projection of the insulating material 130 extends beyond the projection of the holding unit 140B in the direction X and the direction Y so to thermally isolate the holding unit 140B from the carrier 120. However, the disclosure is not limited thereto. Or alternatively, outer edges of the projection of the insulating material 130 may be substantially aligned with outer edges of the projection of the holding unit 140B in the direction X and the direction Y.

In the above embodiments (e.g., 100A and 100B), the insulating material 130 is disposed on the carrier 120, where sidewalls of the insulating material 130 are free from the carrier 120. However, the disclosure is not limited thereto. An inspection apparatus 100C of FIG. 6 and FIG. 7 is similar to the inspection apparatus 100A of FIG. 1 through FIG. 3, a difference is that, in the inspection apparatus 100C of FIG. 6 and FIG. 7, a recess 120op is formed in the carrier 120 to accommodating the insulating material 130, where sidewalls of the insulating material 130 are covered by the carrier 120. The elements similar to or substantially the same as the elements described previously will use the same reference numbers, and certain details or descriptions (e.g., the materials, formation processes, positioning configurations, etc.) of the same elements would not be repeated herein.

As shown in FIG. 6 and FIG. 7, the recess 120op may have an opening hole at the surface S120t of the carrier 120, where the recess 120op may extend toward the surface S120b of the carrier 120 and stop at a position inside the carrier 120. That is, in the direction Z, a height of the recess 120op is less than a thickness of the carrier 120, for example. In some embodiments, the insulating material 130 is disposed inside and fulfilled the recess 120op formed in the carrier 120. As shown in FIG. 6 and FIG. 7, the insulating material 130 is accessibly revealed by the surface S120t of the carrier 120 and is covered by the surface S120b of the carrier 120.

For example, a surface S130t of the insulating material 130 is substantially level with the surface S120t of the carrier 120, as shown in FIG. 6 and FIG. 7. That is, the surface S130t of the insulating material 130 is substantially coplanar to the surface S120t of the carrier 120. In such configuration of the inspection apparatus 100C, the projection of the insulating material 130 extends beyond the projection of the holding unit 140A in the direction X and the direction Y so to thermally isolate the holding unit 140A from the carrier 120, for example.

However, the disclosure is not limited thereto, alternatively, the insulating material 130 is disposed inside and fulfilled the recess 120op formed in the carrier 120 and further protruded out of the surface S120t of the carrier 120 by a non-zero distance. With such configuration, the insulating material 130 may still be accessibly revealed by the surface S120t of the carrier 120 and may still be covered by the surface S120b of the carrier 120. In such configuration, the projection of the insulating material 130 may or may not extend beyond the projection of the holding unit 140A in the direction X, the direction Y or a combination thereof, since the insulating material 130 is protruded out of the carrier 120 and thus is able to separate the holding unit 140A from the carrier 120 in the direction Z.

Similarly, the holding unit 140A in the inspection apparatus 100C may be substituted by a holding unit 140B. An inspection apparatus 100D of FIG. 8 and FIG. 9 is similar to the inspection apparatus 100C of FIG. 6 through FIG. 7, a difference is that, in the inspection apparatus 100D of FIG. 8 and FIG. 9, the holding unit 140A is substituted by a holding unit 140B, where the holding unit 140B includes the first portion 142 and excludes the second portion 144. The elements similar to or substantially the same as the elements described previously will use the same reference numbers, and certain details or descriptions (e.g., the materials, formation processes, positioning configurations, etc.) of the same elements would not be repeated herein.

As shown in FIG. 8 and FIG. 9, the insulating material 130, the holding unit 140B and the cover 160 together form a space R2′ for accommodating the heater 150 and the object to-be-inspected (e.g., 300 in FIG. 15). In some embodiments, the space R2′ may be sized to fit a single heater 150 with a single die disposed thereon. However, in certain embodiments, the space R2′ may be large enough to fit one or multiple sets of a single heater 150 with multiple dies disposed thereon. Or, the space R2′ may be large enough to fit multiple sets of a single heater 150 with a single die disposed thereon. In some embodiments, the heater 150 is directly placed onto the insulating material 130. As shown in FIG. 8, the surface S150b of the heater 150 is in physical contact with the surface S130t of the insulating material 130.

In the configuration of which either the surface (not labeled) of the insulating material 130 is substantially level with the surface S120t of the carrier 120 or the insulating material 130 is protruded out of the carrier 120 by a non-zero distance, the projection of the insulating material 130 extends beyond the projection of the holding unit 140B in the direction X and the direction Y so to thermally isolate the holding unit 140B from the carrier 120. However, the disclosure is not limited thereto. Or alternatively, outer edges of the projection of the insulating material 130 may be substantially aligned with outer edges of the projection of the holding unit 140B in the direction X and the direction Y.

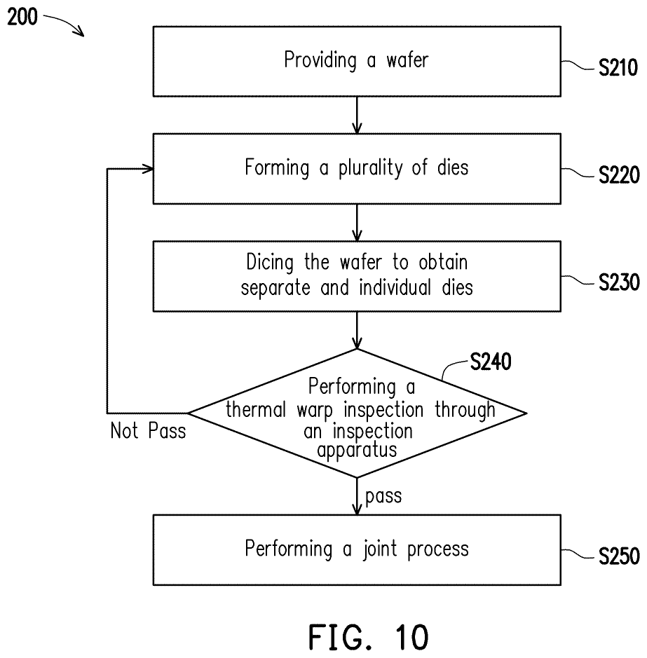

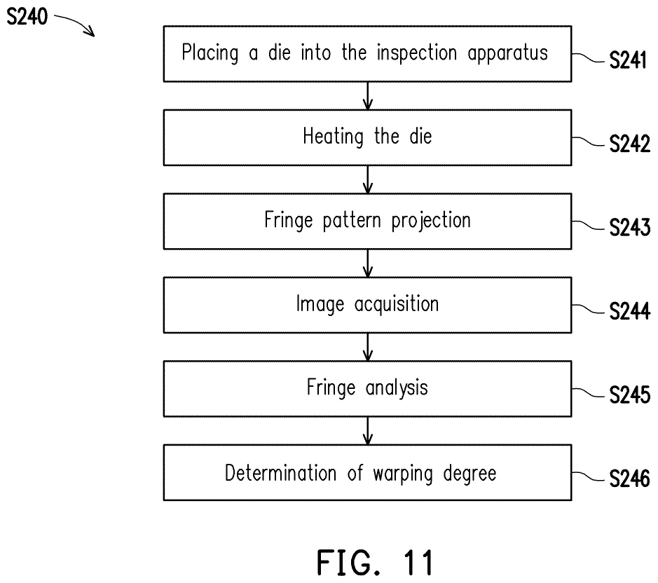

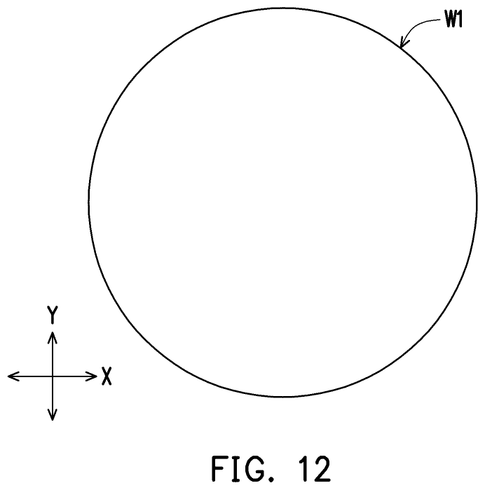

FIG. 10 and FIG. 11 illustrates flowcharts of a method (e.g., 200) for using an inspection apparatus (e.g., 100A, 100B, 100C, or 100D) in accordance with some embodiments of the disclosure. FIG. 12 through FIG. 17 are schematic cross-sectional or plane views of various stages of the method (e.g., 200) using an inspection apparatus (e.g., 100A) for warpage of a semiconductor die (e.g., 300) in accordance with some embodiments of the disclosure. The elements similar to or substantially the same as the elements described previously will use the same reference numbers, and certain details or descriptions (e.g., the materials, formation processes, positioning configurations, etc.) of the same elements would not be repeated herein. In some embodiments, the method is part of a wafer level packaging process. It is understood that additional processes may be provided before, during, and after the illustrated method, and that some other processes may only be briefly described herein. In the disclosure, it should be appreciated that the illustration of components throughout all figures is schematic and is not in scale.

Referring to FIG. 12, in some embodiments, a wafer W1 is provided, in accordance with a step S210 of a method 200 depicted in FIG. 10. The wafer W1 may be a semiconductor wafer. In some embodiments, if considering a top or plane view (e.g., the X-Y plane) along a direction Z, the wafer W1 is in a wafer or panel form. In other words, the wafer W1 is processed in the form of a reconstructed wafer/panel. The wafer W1 may be in a form of wafer-size having a diameter (or a long side) of about 4 inches or more. The wafer W1 may be in a form of wafer-size having a diameter (or a long side) of about 6 inches or more. The wafer W1 may be in a form of wafer-size having a diameter (or a long side) of about 8 inches or more. Or alternatively, the wafer W1 may be in a form of wafer-size having a diameter (or a long side) of about 12 inches or more. The disclosure is not limited thereto.

In some embodiments, the wafer W1 includes a substrate for forming semiconductor dies (or chips) thereon. For example, the substrate includes a bulk semiconductor substrate, a crystalline silicon substrate, a doped semiconductor substrate (e.g., p-type semiconductor substrate or n-type semiconductor substrate), a semiconductor-on-insulator (SOI) substrate, or the like. In certain embodiments, the substrate includes one or more doped regions or various types of doped regions, depending on design requirements. In some embodiments, the doped regions are doped with p-type and/or n-type dopants. For example, the p-type dopants are boron or BF2 and the n-type dopants are phosphorus or arsenic. The doped regions may be configured for an n-type metal-oxide-semiconductor (NMOS) transistor or a p-type MOS (PMOS) transistor. The substrate may be a silicon wafer. Generally, the SOI substrate is a layer of a semiconductor material formed on an insulator layer. The insulator layer is, for example, a buried oxide (BOX) layer, a silicon oxide layer, or the like. Other substrates, such as a multi-layered or a gradient substrate, may also be used. In some alternative embodiments, the substrate includes a semiconductor substrate made of an elemental semiconductor (such as diamond or germanium in a crystalline, a polycrystalline, or an amorphous structure, etc.); a compound semiconductor (such as gallium arsenide, silicon carbide, gallium phosphide, indium phosphide, indium arsenide and/or indium antimonide), an alloy semiconductor (such as silicon-germanium (SiGe), gallium arsenide phosphide (GaAsP), aluminum indium arsenide (AlInAs), aluminum gallium arsenide (AlGaAs), gallium indium arsenide (GaInAs), gallium indium phosphide (GaInP), etc.), combinations thereof, or other suitable materials. For example, the substrate is a silicon bulk substrate. The compound semiconductor substrate may have a multilayer structure, or may include a multilayer compound semiconductor structure. The alloy SiGe may be formed over a silicon substrate. The SiGe substrate may be strained.

Additionally, before forming the semiconductor dies (or chips) on the wafer W1, the wafer W1 may or may not include a wide variety of components (not shown) (also referred to as semiconductor components) pre-formed therein. The pre-formed components may include active components, passive components, or a combination thereof. The pre-formed components may include integrated circuits devices. The pre-formed components may include transistors, capacitors, resistors, diodes, photodiodes, fuse devices, jumpers, inductors, or other similar devices. The functions of the pre-formed components may include memory, processors, sensors, amplifiers, power distribution, input/output circuitry, or the like. The pre-formed components each may be referred to as a semiconductor component.

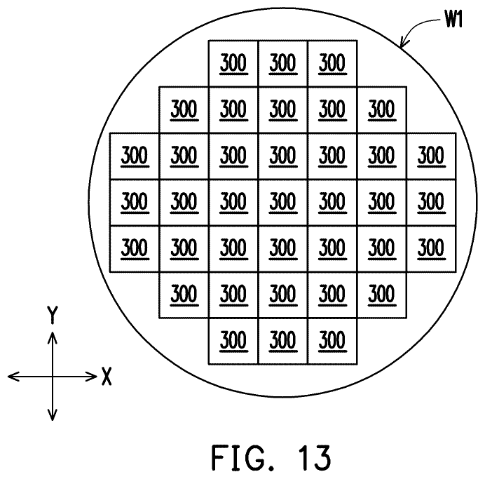

Referring to FIG. 13, in some embodiments, a plurality of semiconductor dies 300 are formed on the wafer W1, in accordance with a step S220 of the method 200 depicted in FIG. 10. For example, the semiconductor dies 300 of the wafer W1 are electrically independent from (e.g., electrically isolated from) each other. The semiconductor dies 300 may be referred to as semiconductor dies or chips, independently, including a digital chip, an analog chip, or a mixed signal chip. The semiconductor dies 300 independently may be or may include a part of a logic die such as a central processing unit (CPU), a graphics processing unit (GPU), a neural network processing unit (NPU), a deep learning processing unit (DPU), a tensor processing unit (TPU), a system-on-a-chip (SoC), a system-on-integrated circuit (SoIC), an application processor (AP), and a microcontroller; a power management die such as a power management integrated circuit (PMIC) die; a wireless and radio frequency (RF) die; a baseband (BB) die; a sensor die such as a photo/image sensor chip; a micro-electro-mechanical-system (MEMS) die; a signal processing die such as a digital signal processing (DSP) die; a front-end die such as an analog front-end (AFE) dies; an application-specific die such as an application-specific integrated circuit (ASIC), a field-programmable gate array (FPGA); a combination thereof; or the like. In alternative embodiments, the semiconductor dies 300 independently may be or may include a part of an artificial intelligence (AI) engine such as an AI accelerator; a computing system such as an AI server, a high-performance computing (HPC) system, a high-power computing device, a cloud computing system, a networking system, an edge computing system, an immersive memory computing system (ImMC), a SoIC system, etc.; a combination thereof; or the like. In addition, the semiconductor dies 300 may further, independently, include one or more functions of an electrical and/or optical input/output (I/O) interface die, an integrated passives die (IPD), a voltage regulator (VR) die, a local silicon interconnect (LSI) die with or without deep trench capacitor (DTC) features, a local silicon interconnect (LSI) die with multi-tier functions such as electrical and/or optical network circuit interfaces, IPD, VR, DTC, or the like. The types of the semiconductor dies 300 may be selected and designated based on the demand and design requirement, and thus are not specifically limited in the disclosure. For example, one of the semiconductor dies 300 includes a die (such as a logic die, a memory die, an optical die, etc.) being further integrated with other dies to form a SoIC device in sequential processes. In other words, such semiconductor die 300 may be referred to as a top die of a later-formed SoIC device (not shown). It is also appreciated that the forming process and material of the semiconductor dies 300 depend on the types of the semiconductor dies 300 being selected and designated and are well-known in the art, which are not to specifically limited in the disclosure, and thus are omitted herein for simplicity.

In some embodiments, the types of all of the semiconductor dies 300 are identical. In alternative embodiments, the types of some of the semiconductor dies 300 are different from each other, while the types of some of the semiconductor dies 300 are identical types. In further alternative embodiments, the types of all of the semiconductor dies 300 are different. In some embodiments, the sizes of all of the semiconductor dies 300 are the same. In alterative embodiments, the sizes of some of the semiconductor dies 300 are different from each other, while the sizes of some of the semiconductor dies 300 are the same sizes. In further alternative embodiments, the sizes of all of the semiconductor dies 300 are different. In some embodiments, the shapes of all of the semiconductor dies 300 are identical. In alternative embodiments, the shapes of some of the semiconductor dies 300 are different from each other, while the shapes of some of the semiconductor dies 300 are identical. In further alternative embodiments, the shapes of all of the semiconductor dies 300 are different. The types, sizes and shapes of each of the semiconductor dies 300 are independent from each other, and may be selected and designed based on the demand and design layout, the disclosure is not limited thereto. In the embodiments of which there are the pre-formed components in the wafer W1, at least one of the semiconductor dies 300 is further electrically coupled to one or more pre-formed components, if need.

Before a wafer sawing or dicing process along scribe or dicing lines (not shown) is performed on the wafer W1 to separate the semiconductor dies 300, the semiconductor dies 300 of the wafer W1 are physically connected to one another, as shown in FIG. 13, for example. Although only thirty-seven semiconductor dies 300 included in the wafer W1 is shown for illustrative purposes, the disclosure is not limited thereto. The number of the semiconductor dies 300 is not specifically limited in the disclosure, and may be selected and designated based on the demand and/or design requirements.

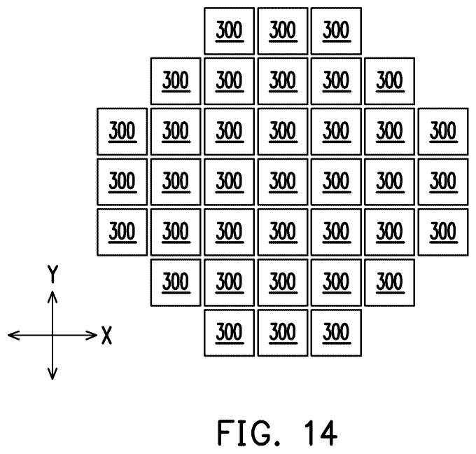

Referring to FIG. 14, in some embodiments, a dicing process is then performed to cut through the wafer W1 along the scribe or dicing lines and form a plurality of trenches (not labeled) separating the semiconductor dies 300 from each other, in accordance with a step S230 of the method 200 depicted in FIG. 10. In one embodiment, the dicing process is a wafer dicing process including mechanical blade sawing or laser cutting.

Referring to FIG. 15, in some embodiments, a thermal warp inspection is performed through an inspection apparatus 100A, in accordance with a step S240 of the method 200 depicted in FIG. 10. One semiconductor die 300 depicted in FIG. 14 may be placed into the inspection apparatus 100A by a pick-and-place method, as shown in FIG. 15 (in accordance with a step S241 in FIG. 11). For example, the semiconductor die 300 is disposed on (in physical contact with) the surface S150t of the heater 150 and covered by the cover 160 in the space R2, where a distance D between the cover 106 and the semiconductor die 300 is greater than zero and is less than or substantially equal to about 3 mm in the direction Z. In the disclosure, each semiconductor die 300 is considered as the object to-be-inspected as mentioned above for its warpage in a thermal environment, such that only the semiconductor dies 300 passing through the inspection can be further undergoing an sequential process such as a joint process for further packaging, thereby improving the yield of manufacture.

After placing the semiconductor die 300 on the heater 150 in the space R2, the heater 150 is under the control of the power supply 170 to heat the semiconductor die 300, as shown in FIG. 15 (in accordance with a step S242 in FIG. 11). For example, the semiconductor die 300 is heated by the heater 150 by direct contact therebetween, where the heating temperature range of such thermal process is approximately from a room temperature to 300° C. Due to the presence of the insulating material 130, most of the heat generated from the heater would not transfer to the carrier 120 and so avoid further heating up the ambient air inside the chamber 102, and thus there is less air disturbance impact inside the space R1. In addition, owing the distance D, the heated ambient air right above the semiconductor 300 is considered relatively small to rest of the surrounding ambient air, and thus there is less air disturbance impact inside the space R2. In some embodiments, during the thermal process, a temperature of the space R2 is greater than a temperature of the space R1. For example, due to almost no heat is escaped to the space R1 (from the space R2), a temperature of the ambient air in the space R1 is substantially equal to the room temperature or slightly higher than the room temperature (e.g., by 10% more). Due to the space R2 (being small), less energy consumption is needed in the thermal warp inspection.

In the thermal warp inspection, the light source 180 may project a light 192 of a pre-determined pattern on the semiconductor die 300, as shown in FIG. 15 (in accordance with a step S243 in FIG. 11). For example, the light projected by the light source 180 may be a visible light having a strip pattern or a visible light having a moiré pattern. After the light projection, a projected light of a resultant pattern can be observed from the semiconductor die 300. Thereafter, an image acquisition is performed (in accordance with a step S244 in FIG. 11). For example, the capture device 190 captures one or more image(s) of the semiconductor die 300. In some embodiments, the capture device 190 captures images of the semiconductor die 300 at different temperatures in the thermal process. In some embodiments, the capture device 190 captures the image of the semiconductor die 300 in a temperature interval, such as every 5° C. temperature increasement, in every 10° C. temperature increasement, in every 15° C. temperature increasement, in every 20° C. temperature increasement, in every 25° C. temperature increasement or combinations thereof. Each time, the number of image being captured by the capture device 190 controlled by the processing unit 104a may be one, two, three, or more, the disclosure is not limited thereto as long as it is enough for data analysis later.

It is noted that the light source 180 controlled by the processing unit 104b may always or periodically project the light for the image acquisition, as long as the light with the pre-determined pattern is projected on the semiconductor die 300 when the capture device 190 is capturing image(s). It is also appreciated that owing to the insulating material 130, there is less air disturbance impact inside the space R1, and owing the distance D, there is less air disturbance impact inside the space R2; thereby the overall air disturbance impact to a light projection (e.g., S243) and an optical data acquisition (e.g., S244) during the thermal warp inspection can be greatly suppressed or reduced.

Then, a fringe analysis of the images may be performed (in accordance with a step S245 in FIG. 11). For example, the processing unit 104a processes the images captured by the capture device 190 from an optical data to a digital data, so to transform the digital data into a 3D surface shape construction (which is done by calculating a distance between the capture device 190 and the semiconductor die 300). In some embodiments, such distance includes a set of distances between the capture device 190 and different locations of the semiconductor die 300, so that a topography of the semiconductor die 300 can be reconstructed to form the 3D surface shape for the semiconductor die 300, which is allow to understand the warpage profile of the semiconductor die 300. In one non-limiting example, if considering a distance between the edge of the semiconductor die 300 and the capture device 190 is greater than a distance between the center of the semiconductor die 300 and the capture device 190, then the 3D surface shape of the semiconductor die 300 would be illustrated or shown as a convex 3D curved surface having a cry-shape in a cross-section thereof. In another non-limiting example, if considering a distance between the edge of the semiconductor die 300 and the capture device 190 is less than a distance between the center of the semiconductor die 300 and the capture device 190, then the 3D surface shape of the semiconductor die 300 would be illustrated or shown as a concave 3D curved surface having a smile-shape in a cross-section thereof. In yet another non-limiting example, if considering a distance between the edge of the semiconductor die 300 and the capture device 190 is substantially equal to a distance between the center of the semiconductor die 300 and the capture device 190, then the 3D surface shape of the semiconductor die 300 would be illustrated or shown as a planar surface having a plate shape in a cross-section thereof. Since the overall air disturbance impact to a light projection (e.g., S243) and an optical data acquisition (e.g., S244) during the thermal warp inspection can be greatly suppressed or reduced, the inspection apparatus (e.g. 100A) has high precision in the thermal warp inspection, with less than 1.5 μm variation.

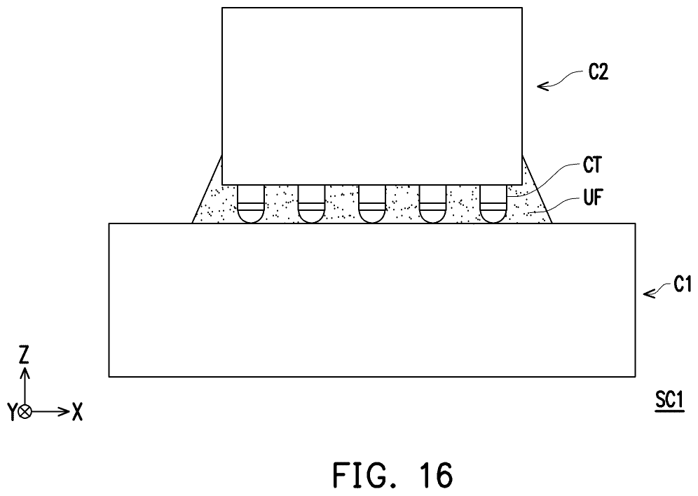

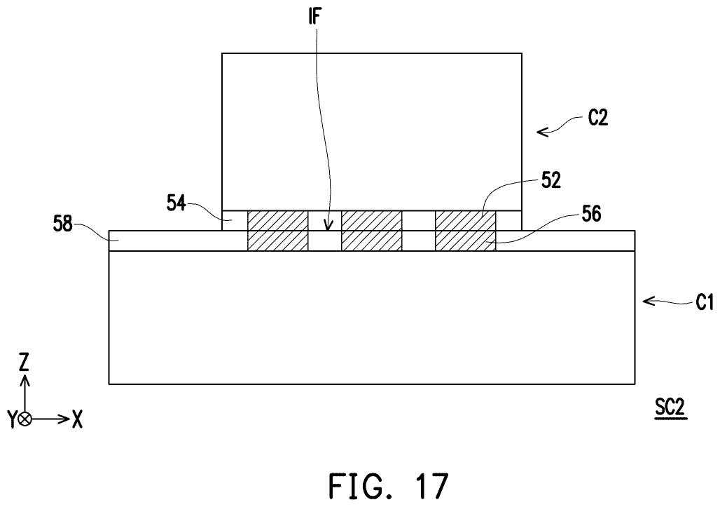

Finally, the warping degree of the semiconductor die 300 may be determined based on the result of fringe analysis (in accordance with a step S246 in FIG. 11). For example, with the warpage profile of the semiconductor die 300 obtained from the fringe analysis, the processing unit 104a is able to determine whether the semiconductor die 300 pass the criteria for a sequential process. For example, the sequential process may include a joint process, and the criteria is thus considered as joint criteria. In the disclosure the criteria is depended on the design rules, that is, the criteria will correspondingly vary (or saying, to be selected and designated) based on the design rules input to the process unit 104a. Therefore, the criteria for determining whether the semiconductor die 300 passing or not passing the thermal warp inspection is not to specifically limited in the disclosure, and thus is omitted herein for simplicity. For example, if the joint process is performed by flip-chop bonding (see FIG. 16), then a joint criteria for the warpage of the semiconductor die 300 cannot be over 15 μm. In addition, if the joint process is performed by a bonding of metal-to-metal bonding and dielectric-to-dielectric bonding (see FIG. 17), then a joint criteria for the warpage of the semiconductor die 300 can be even stricter than the joint criteria of flip-chip bonding. In the step S240 of the method 200, if the warpage of the semiconductor die 300 passes the joint criteria, the method 200 will move to a step S250 for the sequential process. On the other hand, in the step S240 of the method 200, if the warpage of the semiconductor die fails to pass the joint criteria, the method 200 will return to the step S220 and re-adjust parameters of forming process and/or material of the semiconductor die 300 until the semiconductor die 300 pass the thermal warp inspection (e.g., S240). For example, the candidates of parameters may be re-adjusted by, but not limited to, adjusting dielectric materials and/or metal density. In some embodiments, the inspection apparatus 100A may be replaced with the inspection apparatus 100B, 100C, or 100D, the disclosure is not limited thereto. Up to here, the step S240 is ended. That is, the thermal warp inspection of warpage of the semiconductor die 300 can be performed by the inspection apparatus (e.g., 100A, 100B, 100C or 100D). The semiconductor die 300, which passes the thermal warp inspection, may be further mounted to another circuit component in sequential processes, the disclosure is not limited thereto.

For one non-limiting example, referring to FIG. 16, in some embodiments, the warpage of the semiconductor die 300 passes the joint criteria, a joint process is performed to the semiconductor die 300 (which passing the thermal warp inspection), in accordance with the step S250 of the method 200 depicted in FIG. 10. For example, the semiconductor die 300 (which passing the thermal warp inspection) is bonded to another circuit component C1 through the joint process such as a flip-chip bonding, thereby forming a stacked structure SC1, as shown in FIG. 16. In some embodiments, the semiconductor die 300 is connected to and electrically coupled to the another circuit component C1 through a plurality of terminals CT. The terminals CT may be solder regions or conductive connectors. In some embodiments, an underfill UF is formed between the gap of the another circuit component C1 and the semiconductor die 300 to at least laterally cover the terminals CT. Alternatively, the underfill UF is omitted. The underfill UF may be any acceptable material, such as a polymer, epoxy resin, molding underfill, or the like, for example. In one embodiment, the underfill may be formed by underfill dispensing, a capillary flow process, or any other suitable method. Owing to the underfill UF, a bonding strength between the another circuit component C1 and the semiconductor die 300 is enhanced.

In embodiment of which the stacked structure SC1 being the SoIC device (not shown), the semiconductor die 300 may be referred to as the top die of a later-formed SoIC device, the another circuit component C1 may be referred to as a bottom die of the later-formed SoIC device. In such case, the another circuit component C1 may be referred to as another semiconductor die or chip, independently, including a digital chip, an analog chip, or a mixed signal chip. The another circuit component C1 may be or may include a part of a logic die such as a CPU, a GPU, a NPU, a DPU, a TPU, a SoC, a SoIC, an AP, and a microcontroller; a power management die such as a PMIC die; a wireless and RF die; a BB die; a sensor die such as a photo/image sensor chip; a MEMS die; a signal processing die such as a DSP die; a front-end die such as an AFE dies; an application-specific die such as an ASIC, a FPGA; a combination thereof; or the like. In alternative embodiments, the another circuit component C1 may be or may include a part of an AI engine such as an AI accelerator; a computing system such as an AI server, a HPC system, a high-power computing device, a cloud computing system, a networking system, an edge computing system, an ImMC, a SoIC system, etc.; a combination thereof; or the like. In addition, the another circuit component C1 may further include one or more functions of an electrical and/or optical I/O interface die, an IPD, a VR die, a LSI die with or without DTC features, a LSI die with multi-tier functions such as electrical and/or optical network circuit interfaces, IPD, VR, DTC, or the like. The type of the another circuit component C1 may be selected and designated based on the demand and design requirement, and thus is not specifically limited in the disclosure. It is also appreciated that the forming process and material of the another circuit component C1 depend on the types of the another circuit component C1 being selected and designated and are well-known in the art, which are not to specifically limited in the disclosure, and thus are omitted herein for simplicity.

In embodiment of which the stacked structure SC1 being the InFO package, a CoW package, or a CoWoS package, a PoP, an InFO package with POP, a WLP, or the like (not shown), the semiconductor die 300 may be one of dies of a later-formed s semiconductor device (e.g., the InFO package, a CoW package, or a CoWoS package, a PoP, an InFO package with POP, a WLP, or the like), the another circuit component C1 may be or may include a circuit structure, such as a mother board, a package substrate, another PCB, a printed wiring board, an interposer, and/or other carrier that is capable of carrying the semiconductor die 300.

The disclosure is not limited thereto. The joint process may be a bonding including a metal-to-metal bonding and a dielectric-to-dielectric bonding. In other non-limiting example, referring to FIG. 17, the warpage of the semiconductor die 300 passes the joint criteria, a joint process is performed to the semiconductor die 300 (which passing the thermal warp inspection), in accordance with the step S250 of the method 200 depicted in FIG. 10. For example, the semiconductor die 300 (which passing the thermal warp inspection) is bonded to another circuit component C1 through the joint process such as a bonding including a metal-to-metal bonding and a dielectric-to-dielectric bonding, thereby forming a stacked structure SC2, as shown in FIG. 17. The details of the another circuit component C1 have been discussed in FIG. 16, and the details (e.g., types) of the stacked structure SC2 are similar to or substantially identical to the details (e.g., types) of the stacked structure SC1 previously discussed in FIG. 16, and thus are not repeated therein. As shown in FIG. 17, a metallization layer 52 of the semiconductor die 300 and a metallization layer 56 of the another circuit component C1 prop against each other and are bonded together through direct metal-to-metal bonding (e.g., such as a ‘copper’-to-‘copper’ bonding). In addition, as shown in FIG. 17, a dielectric layer 54 of the semiconductor die 300 and a dielectric layer 58 of the another circuit component C1 prop against each other and are bonded together through a direct dielectrics-to-dielectrics bonding (such as a ‘oxide’-to-‘oxide’ bonding, a ‘nitride’-to-‘oxide’ bonding, or a ‘nitride’-to-‘nitride’ bonding), for example. In such embodiments, a bonding interface IF including a metal-to-metal bonding interface (such as a ‘copper’-to-‘copper’ bonding interface) and a dielectric-to-dielectric bonding interface (such as a ‘oxide’-to-‘oxide’ bonding interface, a ‘nitride’-to-‘oxide’ bonding interface, or a ‘nitride’-to-‘nitride’ bonding interface) are co-existing between the semiconductor die 300 and the another circuit component C1, and which is considered as a bonding interface of the semiconductor die 300 and the another circuit component C1.

It should be noted that bonding methods described above are merely examples and are not intended to be limiting. An offset may present between sidewalls of the metallization layer 52 of the semiconductor die 300 and sidewalls of the metallization layer 56 of the another circuit component C1 respectively underlying thereto. Since one of the metallization layer 52 of the semiconductor die 300 and the metallization layer 56 of the another circuit component C1 may have a larger bonding surface than the other one, the direct metal-to-metal bonding may still be achieved even if misalignment occurs, thereby the reliability of electrical connections between the semiconductor die 300 and the another circuit component C1 can be ensured. With such, for certain embodiments, either the dielectric layer 54 immediately adjacent to the metallization layer 52 is bonded to the metallization layer 56 (e.g., a ‘dielectric’-to-‘metal’ bonding), or the dielectric layer 58 immediately adjacent to the metallization layer 56 is bonded to the metallization layer 52 (e.g., a ‘dielectric’-to-‘metal’ bonding). Depending on the demand and design requirement/layout, one or more sequential processes will be further provided to the stacked structures SC1 and/or SC2 so to manufacture the final product, the disclosure is not limited thereto.

In accordance with some embodiments, an inspection apparatus for a warpage of a semiconductor die includes a carrier, a thermal isolation material, a holding unit, a heater, and a cover. The thermal isolation material is disposed over the carrier. The holding unit stands on and is in contact with the thermal isolation material. The heater is disposed inside the holding unit and is configured to heat the semiconductor die. The cover stands on and is in contact with the holding unit, where the semiconductor die is disposed between the cover and the heater and distant from the cover.

In accordance with some embodiments, an inspection apparatus for a warpage of a semiconductor die includes a carrier, a metallic holder, an insulating material, a heater, a transparent cover, a projector, and an optical capture device. The metallic holder is disposed over the carrier. The insulating material is vertically disposed between the carrier and the metallic holder, and the insulating material thermally isolates the metallic holder and the carrier. The heater is disposed inside the metallic holder and is configured to heat the semiconductor die. The transparent cover stands on the metallic holder. The projector is disposed over the transparent cover and is configured to project a pre-determined pattern of a light on the semiconductor die. The optical capture device is disposed over the transparent cover and is configurated to capture an image of the semiconductor die for inspecting the warpage of the semiconductor die.

In accordance with some embodiments, a method of inspecting a warpage of a semiconductor die includes the following steps: heating the semiconductor die; projecting a light having a pattern to the semiconductor die; capturing an image of the semiconductor die; analyzing the image of the semiconductor die; and determining a warpage of the semiconductor die.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure.

What is claimed is:

1. An inspection apparatus for a warpage of a semiconductor die, comprising:
a carrier;
a thermal isolation material, disposed over the carrier;
a holding unit, standing on and in contact with the thermal isolation material;
a heater, disposed inside the holding unit and being configured to heat the semiconductor die; and
a cover, standing on and in contact with the holding unit, wherein the semiconductor die is disposed between the cover and the heater and distant from the cover.

2. The inspection apparatus of claim 1, wherein the holding unit is in form of a ring disposed on the thermal isolation material and extending along with an edge of the thermal isolation material.

3. The inspection apparatus of claim 1, wherein the holding unit comprises:
a ring portion, disposed on the thermal isolation material and extending along with an edge of the thermal isolation material; and
a plate portion, disposed on the thermal isolation material and extending along with a main surface of the thermal isolation material, wherein the plate portion is connected to the ring portion.

4. The inspection apparatus of claim 3, wherein a thickness of the plate portion is less than a thickness of the ring portion.

5. The inspection apparatus of claim 1, wherein the carrier having a first surface and a second surface opposing to the first surface, and a recess disposed in the carrier extends from the first surface towards a position inside the carrier,
wherein the thermal isolation material is disposed in the recess, and the thermal isolation material is accessibly revealed by the first surface and is covered by the second surface.

6. The inspection apparatus of claim 1, further comprising:
a controller, electrically coupled to the heater and being configured to adjust a heating temperature of the semiconductor die.

7. The inspection apparatus of claim 1, further comprising:
a light source, disposed over the cover and being configured to project a light to the semiconductor die;
a capture device, disposed over the cover and being configured to capture an image of the semiconductor die for inspecting the warpage of the semiconductor die after heating; and
a controller, electrically coupled to the capture device and being configured to analysis the image of the semiconductor die.

8. An inspection apparatus for a warpage of a semiconductor die, comprising:
a carrier;
a metallic holder, disposed over the carrier;
an insulating material, vertically disposed between the carrier and the metallic holder, the insulating material thermally isolating the metallic holder and the carrier;
a heater, disposed inside the metallic holder and being configured to heat the semiconductor die;
a transparent cover, standing on the metallic holder;
a projector, disposed over the transparent cover and being configured to project a pre-determined pattern of a light on the semiconductor die; and
an optical capture device, disposed over the transparent cover and being configured to capture an image of the semiconductor die for inspecting the warpage of the semiconductor die.

9. The inspection apparatus of claim 8, wherein the carrier comprises a carbon carrier.

10. The inspection apparatus of claim 8, wherein a material of the metallic holder comprises a metal or a metal alloy.

11. The inspection apparatus of claim 8, wherein a material of the insulating material comprises a heat-resist resin or a heat-isolated ceramic.

12. The inspection apparatus of claim 8, wherein the heater comprises a ceramic coil heater.

13. The inspection apparatus of claim 8, wherein the transparent cover comprises a glass cover being configured to be passed through by a visible light.

14. The inspection apparatus of claim 8, wherein the projector comprises a light source illustrating a visible light, and the pre-determined pattern is a strip pattern or a moiré pattern.

15. The inspection apparatus of claim 8, wherein the semiconductor die is vertically between the heater and the transparent cover, and a distance between the transparent cover and the semiconductor die is greater than zero and is less than or substantially equal to 3 mm.

16. The inspection apparatus of claim 8, further comprising:
a supporting structure, disposed underneath the carrier and being configured to support the carrier;
a power supply, electrically coupled to the heater and being configured to adjust a heating temperature of the semiconductor die; and
a first controller, electrically coupled to the optical capture device and being configured to analysis the image of the semiconductor die.

17. The inspection apparatus of claim 16, further comprising:
a second controller, electrically coupled to the projector and being configured to adjust the pre-determined pattern of the light.

18. A method of inspecting a warpage of a semiconductor die, comprising:
heating the semiconductor die;
projecting a light having a pattern to the semiconductor die;
capturing an image of the semiconductor die;
analyzing the image of the semiconductor die; and
determining a warpage of the semiconductor die.

19. The method of claim 18, prior to heating the semiconductor die, further comprising:
placing the semiconductor die into an inspection apparatus, the inspection apparatus comprising a carrier, a thermal isolation material disposed over the carrier, a holding unit standing on and in contact with the thermal isolation material, a heater disposed inside the holding unit, a transparent cover standing on and in contact with the holding unit, a light source disposed over the transparent cover, and a capture device disposed over the transparent cover, wherein:
the semiconductor die is placed onto and heated by the heater, and is disposed between the transparent cover and the heater,
the light is projected by the light source, and
the image of the semiconductor die is captured by the capture device.

20. The method of claim 18, wherein the determining the warpage of the semiconductor die comprises determining whether the warpage of the semiconductor die passing a joint criteria,
wherein when the warpage of the semiconductor die passes the joint criteria, the semiconductor die is performed with a joint process,
wherein the joint process comprises a flip-chip bonding or a bonding process comprising a metal-to-metal bonding and a dielectric-to-dielectric bonding.
